(19) United States
(12) Patent Application Publication
(10) Pub. No.: US 2019/0173959 A1
(43) Pub. Date: Jun. 6, 2019

(54) INTERACTIVE AUTOMATIC MARKING OF PEER MESSAGES AND EVENTS IN CLOUD-TO-CLOUD OR CLOUD-TO-ENTERPRISE COMMUNICATIONS

(71) Applicant: Cisco Technology, Inc., San Jose, CA (US)

(72) Inventor: Debanjan Biswas, Bangalore (IN)

(21) Appl. No.: 15/833,624

(22) Filed: Dec. 6, 2017

(51) Int. Cl. H04L 29/08; H04L 12/58; G06F 3/0481

(52) U.S. Cl. CPC H04L 67/141; G06F 3/0481; H04L 67/104; H04L 51/16

(57) ABSTRACT

A method includes: at a first network device, entering a connected mode in which the first network device connects to a second network device; receiving a user input to tag an event of the first network device; tagging the event by assigning a unique identifier to the event; and upon tagging the event at the first network device, automatically causing the first network device to send to the second network device a message that includes the unique identifier.

### TECHNICAL FIELD

The present disclosure relates to cloud-to-cloud or cloud-to-enterprise communications.

### BACKGROUND

Troubleshooting collaboration systems in enterprise, service provider hosted systems or cloud systems can be very complex. In the context of communications between an enterprise network and a cloud network, communications between a cloud network and another cloud network, and communications between an enterprise network and a service provider hosted in a cloud network, collaboration systems become even more complex because all of the infrastructures are not managed by a single entity. For example, some data of an entity may be restricted from being shared with other entities because the data is private or confidential. Thus, there is a need to provide a solution for troubleshooting across all isolated systems.

### BRIEF DESCRIPTION OF THE DRAWINGS

FIG. 1 depicts a network environment that includes a plurality of network devices for a collaboration session and in which interactive marking of peer messages and events is provided, according to an example embodiment.

FIG. 2 depicts a block diagram of a network device configured to participate in the interactive marking of peer messages and events, according to an example embodiment.

FIG. 3 is a sequence diagram illustrating a method for conducting a collaboration session between a plurality of network devices in order to support interactive marking of peer messages and events, according to an example embodiment.

FIG. 4 is a flow chart illustrating a method for performing a collaboration session during which interactive marking of peer messages and events is provided, according to an example embodiment.

FIG. 5 is a flow chart illustrating another method for a collaboration session in which interactive marking of peer messages and events is provided, according to an example embodiment.

### DESCRIPTION OF EXAMPLE EMBODIMENTS

### Overview

In one embodiment, a method is provided that includes: at a first network device, entering a connected mode in which the first network device connects to a second network device; receiving a user input to tag an event of the first network device; tagging the event by assigning a unique identifier to the event; and upon tagging the event at the first network device, automatically causing the first network device to send to the second network device a message that includes the unique identifier.

### Example Embodiments

Techniques are presented herein that provide a solution to conduct a collaboration between multiple different backend devices having different graphical user interfaces (GUIs). For example, when a connected mode is invoked, different GUIs connected to different backend devices in different clouds controlled by different providers are all interconnected. In this connected mode, marking/tagging of events at one GUI in a first cloud provider automatically causes sending a message to a connected network device in a remote cloud system. Based on the message, the connected network device identifies one or more events corresponding to the tagged event at the first cloud provider, which may be conducted, for example, based on a unique identifier extracted from the message or based on searching a local event store based on relevance of key words. The connected network device may tag with a unique identifier each of the corresponding event(s) and redirect/refresh of a GUI of connected network device to display the corresponding event(s).

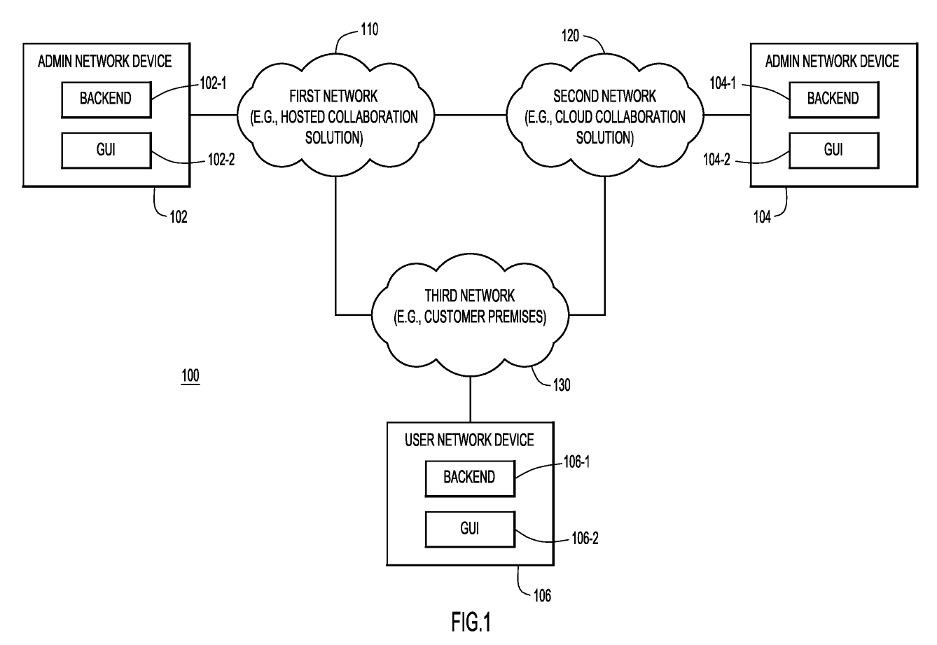

FIG. 1 depicts a network environment 100 that includes a plurality of network devices for a collaboration session in which interactive marking of peer messages and events is provided, according to an example embodiment. As illustrated in FIG. 1, the network environment 100 includes a first network device 102, which, for example, is an administrator (admin) network device of a hosted collaboration solution, a second network device 104, which, for example, is admin network device of a cloud collaboration solution, and a third network device 106, which, for example, is a user network device at a customer premises. Each of the network devices 102, 104, and 106 includes at least a backend function and a GUI. For example, the first network device 102 include a first backend 102-1 and a first GUI 102-2; the second network device 104 include a second backend 104-1 and a second GUI 104-2; and the third network device 106 include a third backend 106-1 and a third GUI 106-2. In some embodiments, the same backend system may be shared by multiple connected GUI. For example, in a collaborative session, two users/admins are logged on from the same enterprise and both of their GUI is connected to the same backend system. Two different users may have access to the same data or different data.

The first network device 102 is deployed in a first network 110, e.g. a hosted collaboration solution network, while the second network device 104 is deployed in a second network 120, e.g., a cloud collaboration solution network, and the third network device 106 is deployed in a third network 130, e.g., a customer premises network. The network devices 102, 104, and 106 are configured to couple to each other via the first, second and third networks 110, 120, and 130. It is to be understood that more or fewer than three network devices may be deployed in the network environment 100. The backend functions referred to above may include network connections for the network devices, generating and transmitting messages between the network devices, or generally other functions that support a collaboration session between the network devices.

The network devices 102, 104, and 106 may be employed for troubleshooting collaboration session, where each of their backends 102-1, 104-1, and 106-1 enables a connected mode in which some local data of each network device may be shared. In the connected mode, each of the network devices can receive user input through their respective GUI. For example, a user may identify an issue related to the troubleshooting collaboration session and instruct the network device 102 to tag an event or message viewable through its GUI 102-2. In one embodiment, each event may be tagged with a unique identifier. When the user identifies multiple events, each of the multiple events may be tagged with a different unique identifier. For example, when it need to resolve multiple call failures, one network device may send details of all the call failures with their respective call identification (call-ID) in the same message to a remote network device in a collaboration session.

In response, the network device 102 tags the event by assigning a unique identifier to the event. Upon tagging the event at the network device 102, the first network device 102 is caused to automatically generate and send to the other network devices 104 and 106 participating in the troubleshooting collaboration session a message that includes the unique identifier. In some embodiments, sending the message by the first network device 102 can happen after a user of the first network device 102 reviews data relevant to the event, or after the user confirms that the message can be send. In some embodiments, the message may further include any comments a user/administrator provides with respect to the tagged event and/or any shared and/or private data related to the tagged event. Additionally or alternatively, the message may include other data, such as logs, protocol specific messages (e.g., session initiation protocol (SIP) messages), part(s) of the SIP message, etc. The backends 104-1 and 106-1 of the other network devices 104 and 106 receive the message and are caused to search their local database to identify a local event corresponding to the tagged event at the network device 102. Upon locating the local event(s), the GUIs 104-2 and 106-2 are configured to display information related to the local event(s) to alert the users/admins of the other network devices 104 and 106. As such, the system 100 can facilitate a collaboration session between multiple network devices in different networks.

In one example, an end-to-end Voice over IP (VoIP) phone call may involve all of the three networks 110, 120, and 130. An IP Phone located in the third network 130 registers to a Call Manager or Communication Manager located in the first network 110. The Call Manager in the first network 110 may be subsequently connected to the second network 120 via an SIP trunk. When the IP Phone dials a specific pattern, the call would be routed to the second network 120. If a user dials from the IP Phone in this specific pattern, the call is supposed to first reach the Call Manager and then the Call Manager will proxy the call/message to the second network 120. If the user dials this pattern and the call fails, the troubleshooting becomes challenging as three different networks are all involved. According to embodiments of this disclosure, the administrators from these networks may join a connected collaboration session to troubleshoot the failure. For example, an administrator from the third network 130 may tag the SIP message and add comments about the failure. The unique identifier for the SIP message in this case could be the SIP Call-ID header or a combination of SIP Call-ID along with a to-tag and a from-tag. Further, the system may generate the unique identifier from a random value. The SIP message and any comments from the administrator(s) may be carried to remote systems in the collaboration session. When the message is received at a network device, the network device searches its storage and identifies any other data with matching details from the incoming event. For example, it could search for local SIP messages with a matching Call-ID, from and to header, etc. Similarly, the above processing will also happen on one or more other network devices in the session. The GUIs of those network devices may be refreshed with this retrieved data to facilitate the collaboration among the administrators.

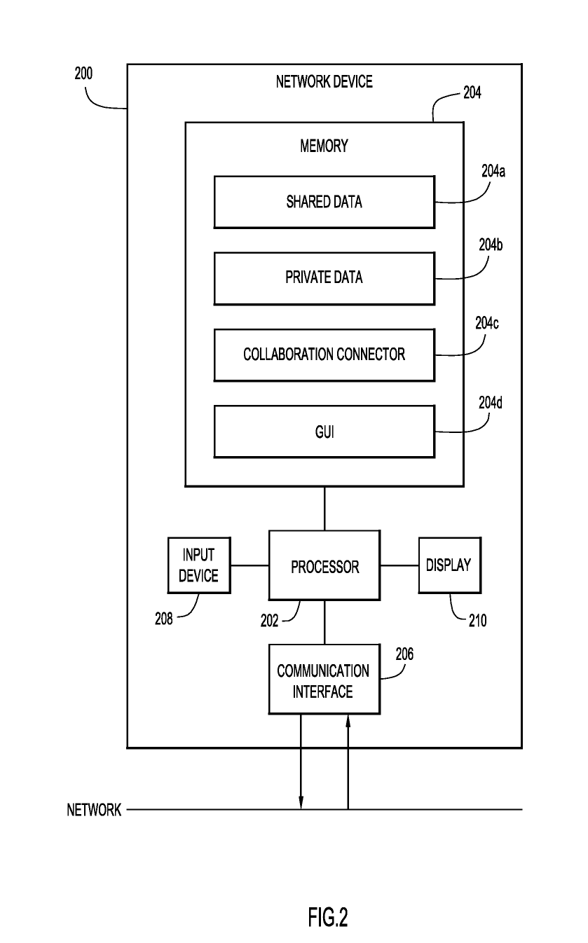

FIG. 2 is a block diagram depicting a network device 200 configured to participate in the interactive marking of peer messages and events, according to an example embodiment. The network device 200 can be any one of the network devices 102, 104, and 106 depicted in FIG. 1. The network device 200 includes a processor 202, a memory 204, a communication interface 206, an input device 208, and a display 210. The processor 202 may be a microprocessor or microcontroller (or multiple instances of such components) that is configured to execute program logic instructions (i.e., software) for carrying out various operations and tasks described herein. For example, the processor 202 is configured to execute instructions stored in the memory 204 to enter a connected mode in which the network device 200 connects to a second network device; to receive a user input to tag an event of the first network device; to tag the event by assigning a unique identifier to the event; and upon tagging the event at the first network device, to automatically cause the network device 200 to send to the second network device a message that includes the unique identifier. Further descriptions of the operations performed by the processor 202 when executing instructions stored in the memory 204 are provided below.

The memory 204 may include read only memory (ROM), random access memory (RAM), magnetic disk storage media devices, optical storage media devices, flash memory devices, electrical, optical or other physical/tangible memory storage devices now known or hereinafter developed.

The functions of the processor 202 may be implemented by logic encoded in one or more tangible (non-transitory) computer-readable storage media (e.g., embedded logic such as an application specific integrated circuit, digital signal processor instructions, software that is executed by a processor, etc.), wherein the memory 204 stores data, such as shared data 204a and private data 204b, used for the operations described herein, and stores software or processor executable instructions, such as for a collaboration connector 204c, that are executed to carry out the operations described herein. In addition, the memory 204 stores instructions for a GUI 204d for graphical user interface interactions with a user of the network device 200.

The collaboration connector 204c may take any of a variety of forms, so as to be encoded in one or more tangible/non-transitory computer readable memory media or storage device for execution, such as fixed logic or programmable logic (e.g., software/computer instructions executed by a processor), and the processor 202 may be an application-specific integrated circuit (ASIC) that comprises fixed digital logic, or a combination thereof.

For example, the processor 202 may be embodied by digital logic gates in a fixed or programmable digital logic integrated circuit, which digital logic gates are configured to perform the collaboration connector 204c. In general, the collaboration connector 204c may be embodied in one or more computer-readable storage media encoded with software comprising computer executable instructions and when the software is executed operable to perform the operations described herein.

The communication interface 206 is configured to enable network communications and transmit signals to or receive signals from a network for the network device 200. In one example, the communication interface 206 may take the form of one or more network interface cards or networking devices. For example, the communication interface 206 may receive a message including a unique identifier from another network device or send a message including a unique identifier to another network device.

The input device 208 is coupled to the processor 202 and configured to enable a user to input instructions or data into the network device 200. For example, the input device 208 may be one or more of a keyboard, a microphone, a mouse, a touch panel, etc., or generally, any other device that may be employed by a user to input instructions or data into the network device 200.

The display 210 is coupled to processor 202 and configured to display images or data, such as images or data associated with a GUI function. The display 210 may be a flat screen or a touch screen that allows users to draw or write on it during a collaboration session. It is to be understood that there may be one or more additional processing ASICs connected between the input device 208 and/or display 210 and the processor 202 to facilitate the respective functions of those components and interaction with the processor 202. Those processing ASICs are omitted in FIG. 2 for simplicity.

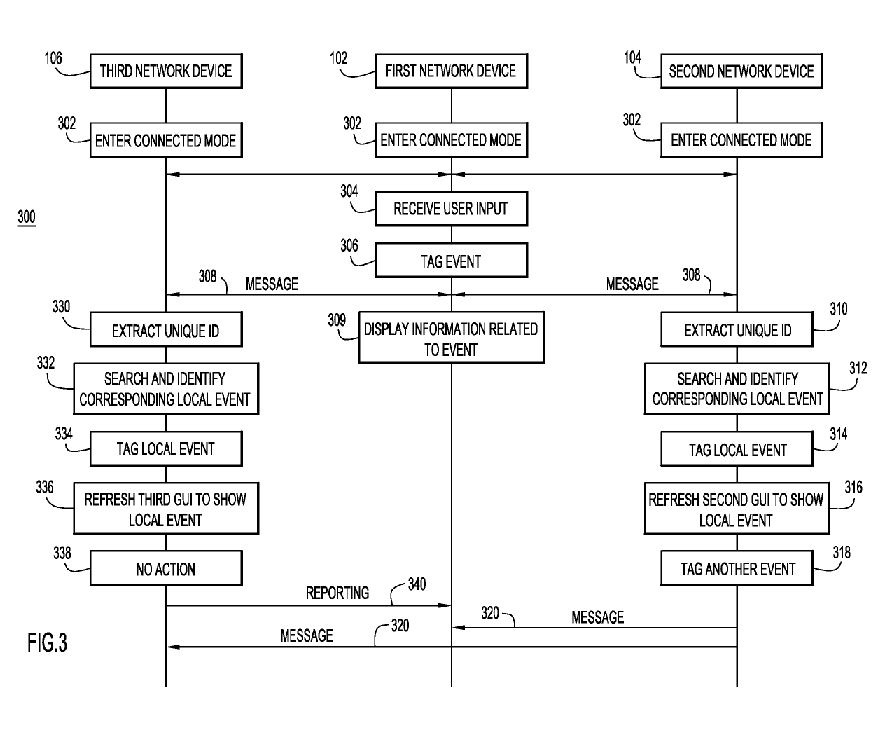

Techniques for conducting a collaboration session in the network environment 100 in order to support interactive marking of peer messages and events will be explained with reference to FIGS. 1-3. FIG. 3 is a sequence diagram illustrating a method 300 for conducting a collaboration session between network devices with interactive marking of peer messages and events, according to an example embodiment. At 302, each of the network devices 102, 104, and 106 enters a connected mode. For example, each of the network devices 102, 104, and 106 executes a collaboration connector function to enter the connected mode. In the connected mode, the backends and/or GUIs of the network devices 102, 104, and 106 are connected to each other via the different networks, e.g., networks 110, 120, and 130. Also in the connected mode, the network devices 102, 104, and 106 can allow a connected network device to access all or a portion of local data. For example, each of the network devices 102, 104, and 106 in their respective memories stores shared and private data. Each of the network devices 102, 104, and 106 (e.g., 102) can allow only the shared data to be accessed by a connected partner (e.g., 104 or 106) or both the shared data and private data to be accessed by a connected partner. Each of the network devices 102, 104, and 106 may define what constitutes shared or private data. For example, private data may include personal or confidential data of a user or enterprise.

In some embodiments, a first network device may enter into a connected mode and receives user inputs of one or more comments, unique identifiers, and/or data when no other network device are connected. When the other network devices with relevant access details enter into the connected mode, they may be able to see the messages from the first network device and perform all the operations described herein.

At 304, the first network device 102 receives user input to tag an event of the first network device. Examples of an event may be a time when an Internet Protocol (IP) phone call is initiated or an account that initiated the IP phone call or the use of hardware device for the IP phone call. At 306, the first network device 102 tags the event by assigning a unique identifier to the event. Upon tagging the event at the first network device 102, at 308, the first network device 102 automatically sends to the second network device 104 and/or the third network device 106 a message that includes the unique identifier. In some embodiments, the message is sent to all or a subset of other network device(s) in the communication session. Examples of a unique identifier include a combination of numbers and/or letters. In some embodiments, the message may further include any comments a user/administrator provides with respect to the tagged event and/or any shared and/or private data related to the tagged event. At 309, the first GUI 102-2 of the first network device 102 is configured to display information related to the tagged event. The displayed information related to the event may facilitate an administrator/user to participate in the collaboration session.

At 310, the second network device 104 receives the message sent by the first network device 102 and extracts the unique identifier from the message. At 312, the second network device 104 searches in a database and identifies, based on the message, a local event of the second network device 104 corresponding to the tagged event of the first network device 102. For example, a database may be a relational database management system (RDBMS), or a non-Structured Query Language (NoSQL) database, and may include text files, log files, network packets, hard disk, remote storage, etc. For example, the search may be based on the unique identifier extracted from the message, or key words, comments, or data included in the message. At 314, the second network device 104 tags the local event with the unique identifier. At 316, in response to tagging of the local event, the second network device 104 refreshes its second GUI 104-2 to display information related to the local event. The displayed information related to the local event may facilitate an administrator/user of the second network device 104 to participate in the collaboration session. In one embodiment, the displayed information may also include the comments included in the message, which is provided by the administrator/user associated with the first network device 102. Thus, the user's attention may be directed to review the information related to the local event and the comments of another user to improve effectiveness of the collaboration session.

In addition, the user of the second network device 104 may provide additional comments on the local event, and be inspired to tag and provide comments on another local event at the second network device 104. If that happens, at 318 the second network device 104 receives a user input to tag a second local event at the second network device 104. After the second network device 104 tags the second local event, operations similar to those of operations at 306-309 are performed. At 320, the second network device 104 is caused to automatically send to all of other network devices participated in the collaboration session (here, the first network device 102 and the third network device 106) a second message that includes a unique identifier of the second local event at the second network device 104. After each of the first network device 102 and the third network device 106 receives the second message, the first network device 102 or the third network device 106 is configured to perform operations similar to those of operations 310-316. In some embodiments, when the second network device 104 is performing the operations 310-318, the first network device 102 or the third network device 106 may be in or may not be in the connected mode (i.e., connected or disconnected).

Further details are now described about the message sent at 308 from the first network device 102 to the third network device 106. Still referring to FIG. 3, at 330 the third network device 106 receives the message and extracts the unique identifier from the message. At 332, the third network device 106 searches in a database and identifies, based on the message, a local event of the third network device 106 corresponding to the tagged event of the first network device 102. For example, a database may be an RDBMS or NoSQL database, and may include text files, log files, network packets, hard disk, remote storage, etc. For example, the search may be based on the unique identifier extracted from the message, or key words, comments, or data included in the message. At 334, the third network device 106 tags the local event with the unique identifier. At 336, the third network device 106 refreshes its third GUI 106-2 to display information related to the local event. In some embodiments, after the third network device 106 displays the information related to the local event and comments and/or data included in the message, at 338 the third network device receives no user input thereto. At 340, the third network device 106 may simply send to the first network device 102 an acknowledgement or report indicating receipt of the message.

The embodiments described enable an effective collaboration session to be conducted among multiple network devices having different GUIs deployed in different networks in a hybrid-cloud setup. As illustrated in FIG. 1, the hosted collaboration network 110, the cloud collaboration network 120, and the customer premises network 130, may be connected via a collaboration connector. The collaboration connectors are deployed in all three networks providing access to all or partial data available locally. The collaboration connector may also filter out the personal and confidential data and pass messages and events that are relevant for the collaboration session to the other connected network devices. When the collaboration connector residing in one network device prepares to send a message related to a tagged event to other network devices, the collaboration connector can add a unique identifier to the event, which is unique across all messages. In one embodiment, the unique identifier could be an identifier of a protocol message that is transmitted between the systems. For example, in an IP call the unique identifier could be a Call-ID in the SIP message. With this unique identifier, all administrators/users participating in the collaboration session can look at their version of the data stored locally, in their respective GUI.

In one embodiment, a collaboration session is initiated to debug a hybrid call failure between an endpoint and an internet protocol (IP) phone registered to a hosted cloud bridged by a cloud collaboration provider. Respective administrators/users may login to their local GUI of a troubleshooting/collaboration connector. The connector provides a unique mode of operation-connected mode. Generally, in this connected mode, the backend system of the GUI maintains secure connections to remote backend systems of other cloud based systems and helps sharing of data between them. When the administrators/users look into the details of local events in their local systems, they can mark/tag some events and add comments. Marking/tagging of an event and/or adding of comments in one system cause a new set of secondary events at the remote systems. In particular, marking/tagging of an event causes a system to send a message including a unique identifier to uniquely identify the event. The unique identifier may be used at the remote systems to locate a local event corresponding to the event that was tagged with the unique identifier. Once the corresponding local event is identified, the local event can also be tagged/marked with the unique identifier. Other relevant information from the local systems may be marked/tagged as additional details. One aspect of the present techniques is the process by which tagging a local event triggers a communication, e.g., a message, to remote systems, which results in finding the corresponding event(s) based on, e.g., the unique identifier, key words, comments, etc. The message may include data for searching in local event/message storage for tagging all relevant events/messages in the remote cloud system. The information related to the local event is viewable by the admin of that remote cloud system via a GUI.

If comments are provided, then the message may also include these comments. These secondary events (e.g., comments or related information) may be considered as metadata for the primary/tagged event(s). Tagging an event causes an automatic or semi-automatic (after receiving confirmation from the admin) redirection or refreshing of GUI page(s) of the admin at the cloud infrastructure. Thus, generally an action of an admin at one cloud system causes automatic/semi-automatic redirection or refreshing a GUI page for another admin in a cloud provider. The operations of the network devices enable a remote admin to review the messages and/or local events at the local systems, view the comments from another admin, provide a reply/forward comment, and do additional tagging.

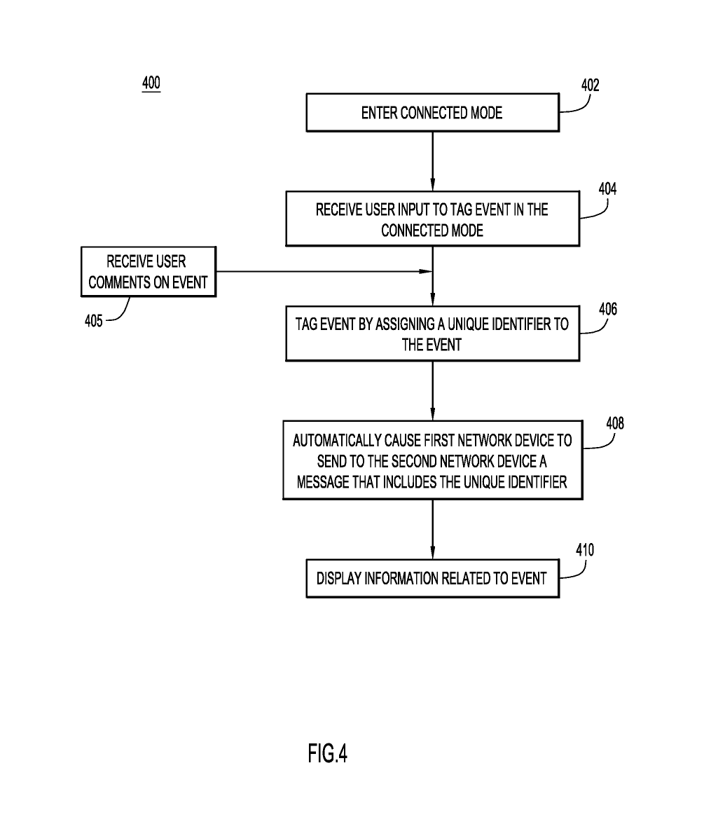

Reference will now be made to FIG. 4. FIG. 4 is a flow chart illustrating a method 400 for a collaboration session during which interactive marking of peer messages and events is provided, according to an example embodiment. For example, the method 400 may be performed by any one of the network devices 102, 104, and 106 shown in FIG. 1. At 402, a network device enters a connected mode in which the network device connects to another network device. For example, the network device may execute a collaboration connector to enter the connected mode. In the connected mode, backends and/or GUIs of the network devices are connected to each other via one or more networks. Also in the connected mode, each of the participating network devices can allow a connected network device to access all or a portion of its local data. At 404, the network device receives user input to tag an event of the network device in the connected mode. At 405, the network device may further receive user comments on the event. At 406, the network device tags the event by assigning a unique identifier to the event. At 408, upon tagging the event, the network device automatically causes to send to another network device a message that includes the unique identifier. In some embodiments, the message may further include user comments on the tagged event and/or other data related to the tagged event. At 410 the network device displays, by a GUI of the network device, information related to the tagged event.

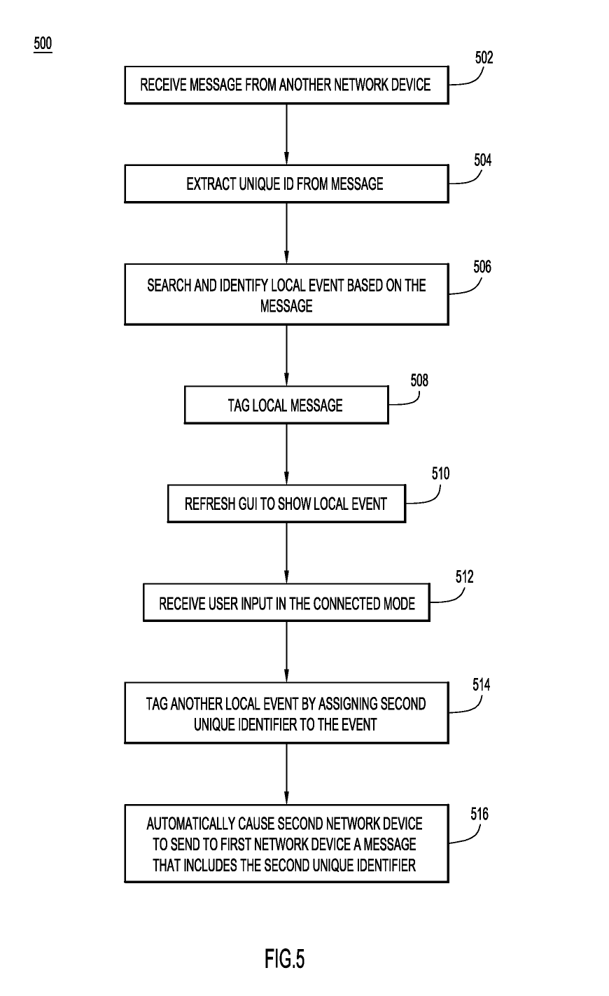

Example operations of a network device receiving the message sent at 408 will be described with reference to FIG. 5. It is to be understood that the operations depicted in FIG. 5 may be performed by any network device participating in a collaboration session. At 502, a second network device in the connected mode in the collaboration session receives the message sent by a first network device (e.g., the network device depicted in FIG. 4). At 504, the second network device extracts the unique identifier from the message. At 506, the second network device searches in a local database and identifies based on the message a local event corresponding to the tagged event. The searching and identifying may be based on the unique identifier, user comments, key words, and/or data included in the message. Once the corresponding local event is identified, at 508 the second network device tags the local event with the unique identifier extracted from the message. At 510, tagging the local event causes the second network device to automatically refresh its GUI to display information related to the local event of the second network device. In one embodiment, the displayed information includes user comments on the tagged event at the first network device.

In some embodiments, at 512 the second network device receives user input to tag a second local event. This can happen after 510 when the second network device displays the information related to the first local event of the second network device or at any other moment when a user of the second network device enters input. For example, the user of second network device may review the information related to the first local event which is displayed due to receipt of the message and decide to tag a second local event that is relevant to the first local event. At 514, the second network device tags the second local event by assigning a second unique identifier to the second local event. At 516, upon tagging the second local event, the second network device automatically causes to send to other network devices a message that includes the second unique identifier. In some embodiments, the message may further include the user comments on the second local event and/or other data related to the second local event.

In some embodiments, after the second network device receives the message at 502, it identifies that the message, identifier, or comment sent by the first network device does not relate to any data in the second network device. The second network device then sends back a message to the first network device indicating that an incoming event or message does not have any relevance to the second network device and may ask the first network device to investigate more from its side.

The techniques disclosed herein include several unique features. First, tagging an event in one system can cause an automatic communication to a remote cloud system, which causes finding a corresponding event(s) based on a unique identifier of the event or data relevant to the tagged event and tagging the corresponding event(s) in the remote cloud system. The remote cloud system includes a network device, which displays information related to the corresponding event viewable by an admin of the remote cloud system.

In another feature, a system and method are provided in which different GUIs and their backend systems in different networks (e.g., cloud, hosted, on premise) are connected and data is shared. In the connected mode, one action (e.g., tagging an event) performed in one system causes operations on a remote system(s), which alert a remote admin user of some local event(s) corresponding to the action. The action (tagging an event) also causes an automatic or semi-automatic (after confirmation from an admin) redirection or refreshing of GUI for the remote admin at the remote system.

Also, the techniques disclosed herein enable users of the connected network device to select/tag an event or events and add a comment, which causes communication to the remote side. The communication may be in a form of a message that carries a unique identifier for automatically identifying relevant information on a remote GUI and the comment.

In yet another feature, the techniques disclosed herein allows users of a collaboration session to have the ability to comment, reply, forward events, messages, and/or data between different GUIs each having their own independent backend systems. Those techniques may provide a seamless experience to help administrators at different network systems troubleshoot between two or more systems, e.g., enterprise, hosted, and cloud systems. Those techniques enable easy debugging and use less time to resolve a collaboration issue, resulting in saving in business cost and improved user experiences in debugging hybrid cloud issues.

In some embodiments, a unique identifier could be an ID that allows a related message to be identified in a remote network system. For example, in a VoIP SIP call, the Call-ID could be used as a unique identifier. In some embodiments, when two network devices exchange multiple messages, they may include a same unique identifier or use different unique identifiers.

In summary, in one aspect, a method is provided. The method includes: at a first network device, entering a connected mode in which the first network device connects to a second network device; receiving a user input to tag an event of the first network device; tagging the event by assigning a unique identifier to the event; and upon tagging the event at the first network device, automatically causing the first network device to send to the second network device a message that includes the unique identifier.

In another aspect, an apparatus is provided, which includes a network interface configured to enable network communications, a processor, and a memory to store data and instructions executable by the processor. The processor is configured to execute the instructions to: enter a connected mode in which the apparatus connects to a network device; receive a user input to tag an event at the apparatus; tag the event by assigning a unique identifier to the event; and upon tagging the event at the apparatus, automatically cause the apparatus to send to the network device a message that includes the unique identifier.

In yet another aspect, a non-transitory computer-readable storage media is provided. The non-transitory computer-readable storage media is encoded with software comprising computer executable instructions which, when executed by a processor of an apparatus, cause the processor to: enter a connected mode in which the apparatus connects to a network device; receive a user input to tag an event at the apparatus; tag the event by assigning a unique identifier to the event; and upon tagging the event at the apparatus, automatically cause the apparatus to send to the network device a message that includes the unique identifier.

The above description is intended by way of example only. Various modifications and structural changes may be made therein without departing from the scope of the concepts described herein and within the scope and range of equivalents of the claims.

What is claimed is:

1. A method comprising:
at a first network device, entering a connected mode in which the first network device connects to a second network device;
receiving a user input to tag an event of the first network device;
tagging the event by assigning a unique identifier to the event; and
upon tagging the event at the first network device, automatically causing the first network device to send to the second network device a message that includes the unique identifier.

2. The method of claim 1, further comprising:
displaying, by a first graphical user interface of the first network device, information related to the event; and
receiving as input via the first graphical user interface user comments on the event,
wherein the message further includes the user comments on the event.

3. The method of claim 2, wherein the first network device is in a first network and the second network device is in a second network different from the first network.

4. The method of claim 3, further comprising:
at the second network device, receiving the message;
extracting the unique identifier from the message;
searching in a database, based on the message, for a local event of the second network device corresponding to the event of the first network device; and
tagging with the unique identifier the local event of the second network device .

5. The method of claim 4, further comprising:
in the connected mode, connecting the first graphical user interface of the first network device with a second graphical user interface of the second network device, the second graphical user interface being different from the first graphical user interface,
wherein tagging the event at the first network device automatically triggers a refresh of the second graphical user interface to display information related to the local event of the second network device.

6. The method of claim 4, wherein tagging of the local event of the second network device causes the second network device to display information related to the local event.

7. The method of claim 6, wherein tagging of the local event at the second network device causes second network device to display the user comments together with the information related to the local event.

8. The method of claim 4, wherein the first network device and the second network device are in communication as part of an online collaboration session, and the event is a troubleshooting event associated with the online collaboration session.

9. An apparatus comprising:
a network interface configured to enable network communications;
a processor; and
a memory to store data and instructions executable by the processor,
wherein the processor is configured to execute the instructions to:
enter a connected mode in which the apparatus connects to a network device;
receive a user input to tag an event at the apparatus;
tag the event by assigning a unique identifier to the event; and
upon tagging the event at the apparatus, automatically cause the apparatus to send to the network device a message that includes the unique identifier.

10. The apparatus of claim 9, wherein the processor is further configured to:
display, by a first graphical user interface of the apparatus, information related to the event; and
receive as input via the first graphical user interface user comments on the event,
wherein the message further includes the user comments on the event.

11. The apparatus of claim 10, wherein the processor is further configured to:
in the connected mode, connect the first graphical user interface of the apparatus with a second graphical user interface of the network device, the second graphical user interface being different from the first graphical user interface,
wherein tagging the event at the apparatus automatically triggers a refresh of the second graphical user interface to display information related to a local event of the network device corresponding to the event of the apparatus.

12. The apparatus of claim 10, wherein the apparatus is in a first network and the network device is in a second network different from the first network.

13. The apparatus of claim 12, wherein the message is a first message, the unique identifier is a first unique identifier, the event is a first event, the network interface receives a second message from the network device, and the processor is further configured to:
extract a second unique identifier from the second message;
search a database, based on the second message, in for a second event at the apparatus; and
tag with the second unique identifier the second event at the apparatus.

14. The apparatus of claim 13, wherein tagging of the second event causes the processor to display information related to the second event.

15. The apparatus of claim 10, wherein the processor is configured to display the information related to the local event by displaying the user comments together with the information related to the local event.

16. The apparatus of claim 11, wherein the apparatus and the network device are in communication as part of an online collaboration session, and the event is a troubleshooting event associated with the online collaboration session.

17. A non-transitory computer-readable storage media encoded with software comprising computer executable instructions which, when executed by a processor of an apparatus, cause the processor to:
enter a connected mode in which the apparatus connects to a network device;
receive a user input to tag an event at the apparatus;
tag the event by assigning a unique identifier to the event; and
upon tagging the event at the apparatus, automatically cause the apparatus to send to the network device a message that includes the unique identifier.

18. The non-transitory computer-readable storage media of claim 17, wherein the instructions cause the processor to:
display, by a first graphical user interface of the apparatus, information related to the event; and
receive as input via the first graphical user interface user comments on the event,
wherein the message further includes the user comments on the event.

19. The non-transitory computer-readable storage media of claim 18, wherein the instructions cause the processor to:
in the connected mode, connect the first graphical user interface of the apparatus with a second graphical user interface of the network device, the second graphical user interface being different from the first graphical user interface,
wherein tagging the event at the apparatus automatically triggers a refresh of the second graphical user interface to display information related to a local event of the network device corresponding to the event of the apparatus.

20. The non-transitory computer-readable storage media of claim 19, wherein the apparatus and the network device are in communication as part of an online collaboration session, and the event is a troubleshooting event associated with the online collaboration session.
